(19) United States
(12) Patent Application Publication
(10) Pub. No.: US 2024/0007409 A1
(43) Pub. Date: Jan. 4, 2024

(54) SYSTEMS AND METHODS FOR SIDELINK TRANSMISSION

(71) Applicant: Samsung Electronics Co., Ltd., Suwon-si (KR)

(72) Inventors: Liang HU, San Diego, CA (US); Philippe SARTORI, Naperville, IL (US); Yaser Mohamed Mostafa Kamal FOUAD, San Diego, CA (US)

(21) Appl. No.: 18/331,902

(22) Filed: Jun. 8, 2023

Related U.S. Application Data
(60) Provisional application No. 63/356,630, filed on Jun. 29, 2022.

(51) Int. Cl. H04L 47/27; H04W 28/02

(52) U.S. Cl. CPC H04L 47/27; H04W 28/0284

(57) ABSTRACT

Systems and methods for sidelink transmission. In some embodiments, a method includes: determining, by a User Equipment (UE), a measure of channel congestion, the measure of channel congestion being a channel busy ratio or a channel occupancy ratio; determining, by the UE, a determined contention window size, based on the measure of channel congestion; and waiting, during a first interval of time, without making a sidelink transmission, wherein a length of the first interval of time is based on the determined contention window size.

### CROSS-REFERENCE TO RELATED APPLICATION

This application claims the priority benefit under 35 U.S.C. § 119(e) of U.S. Provisional Application No. 63/356,630, filed on Jun. 29, 2022, the disclosure of which is incorporated by reference in its entirety as if fully set forth herein.

### TECHNICAL FIELD

The disclosure generally relates to wireless communications. More particularly, the subject matter disclosed herein relates to improvements to sidelink communications in a wireless network.

### SUMMARY

In a wireless network, User Equipments (UEs) may communicate with each other and with other devices through a network node (gNB). Such communications may be unreliable, however, or may fail, if an adequate signal path does not exist between a UE and a gNB.

To solve this problem, in situations in which an adequate direct signal path exists between UEs between which communications are to be exchanged, the UEs may communicate directly with each other. Such communications may be referred to as sidelink communications. Sidelink communications may occur in licensed spectrum or in unlicensed spectrum. In unlicensed spectrum, transmissions by a UE may be governed by a contention window, the size of which may be referred to as a contention window size.

One issue with the above approach is that a suitable method for setting the contention window size may be needed. To overcome this issue, systems and methods are described herein for setting the contention window size. The above approaches improve on previous methods because they enable UEs to transmit sidelink transmissions within the unlicensed spectrum.

According to an embodiment of the present disclosure, there is provided a method including: determining, by a User Equipment (UE), a measure of channel congestion, the measure of channel congestion being a channel busy ratio or a channel occupancy ratio; determining, by the UE, a determined contention window size, based on the measure of channel congestion; and waiting, during a first interval of time, without making a sidelink transmission, wherein a length of the first interval of time is based on the determined contention window size.

In some embodiments: the first interval of time is an interval that ends when a random number of channel idle time slots have passed; and the random number is selected to be between 0 and a number that is one less than the contention window size.

In some embodiments, the determining of the determined contention window size includes: determining that the measure of channel congestion is less than a first threshold and less than a second threshold; and in response to determining that the measure of channel congestion is less than the first threshold and less than the second threshold, selecting, from among: a first contention window size and a second contention window size, greater than the first contention window size, the first contention window size as the determined contention window size.

In some embodiments, the determining of the contention window size further includes: determining that the measure of channel congestion is greater than a first threshold and greater than a second threshold; and in response to determining that the measure of channel congestion is greater than the first threshold and greater than the second threshold, selecting, from among: a first contention window size and a second contention window size, greater than the first contention window size, the second contention window size as the determined contention window size.

In some embodiments, the determining of the contention window size further includes: determining that the measure of channel congestion is between a first threshold and a second threshold; and in response to determining that the measure of channel congestion is between the first threshold and the second threshold, leaving unchanged the determined contention window size.

In some embodiments, the determining of the determined contention window size includes: determining a number of negative acknowledgements (NACKs) in a reference duration; and determining the determined contention window size based on the number of NACKs in the reference duration.

In some embodiments, the determining of the determined contention window size based on the number of NACKs in the reference duration includes: determining that the number of NACKs in the reference duration exceeds a threshold, the threshold being based on a measure of channel congestion; and in response to determining that the number of NACKs in the reference duration exceeds the threshold, selecting, from among: a first contention window size and a second contention window size, greater than the first contention window size, the second contention window size as the determined contention window size.

In some embodiments, the determining of the determined contention window size based on the number of NACKs in the reference duration includes determining that the number of NACKs in the reference duration is less than a threshold, the threshold being based on a measure of channel congestion; and in response to determining that the number of NACKs in the reference duration is less than the threshold, selecting, from among: a first contention window size and a second contention window size, greater than the first contention window size, the first contention window size as the determined contention window size.

In some embodiments, the determining of the determined contention window size includes determining of the determined contention window size based on the ratio of: the number of NACKs in the reference duration, to the number of acknowledgments (ACKs) and NACKs in the reference duration.

In some embodiments, the reference duration is defined: to begin in a slot in which the UE obtains channel access to perform a first transmission of a transport block; and to end at the earlier of: when the UE receives a NACK, or when a set time expires.

In some embodiments, the reference duration is defined: to begin in a slot in which the UE obtains channel access to perform a first transmission of a transport block; and to end at the earlier of: when the UE receives an acknowledgment (ACK) or a NACK, or when a set time expires.

In some embodiments, the reference duration is defined to be a set duration.

According to an embodiment of the present disclosure, there is provided a system, including: a User Equipment (UE) including: one or more processors; and a memory storing instructions which, when executed by the one or more processors, cause performance of: determining, by a User Equipment (UE), a measure of channel congestion, the measure of channel congestion being a channel busy ratio or a channel occupancy ratio; determining, by the UE, a determined contention window size, based on the measure of channel congestion; and waiting, during a first interval of time, without making a sidelink transmission, wherein a length of the first interval of time is based on the determined contention window size.

In some embodiments: the first interval of time is an interval that ends when a random number of channel idle time slots have passed; and the random number selected to be between 0 and a number that is one less than the contention window size.

In some embodiments, the determining of the determined contention window size includes: determining that the measure of channel congestion is less than a first threshold and less than a second threshold; and in response to determining that the measure of channel congestion is less than the first threshold and less than the second threshold, selecting, from among: a first contention window size and a second contention window size, greater than the first contention window size, the first contention window size as the determined contention window size.

In some embodiments, the determining of the contention window size further includes: determining that the measure of channel congestion is greater than a first threshold and greater than a second threshold; and in response to determining that the measure of channel congestion is greater than the first threshold and greater than the second threshold, selecting, from among: a first contention window size and a second contention window size, greater than the first contention window size, the second contention window size as the determined contention window size.

In some embodiments, the determining of the contention window size further includes: determining that the measure of channel congestion is between a first threshold and a second threshold; and in response to determining that the measure of channel congestion is between the first threshold and the second threshold, leaving unchanged the determined contention window size.

In some embodiments, the determining of the determined contention window size includes: determining a number of negative acknowledgements (NACKs) in a reference duration; and determining the determined contention window size based on the number of NACKs in the reference duration.

In some embodiments, the determining of the determined contention window size based on the number of NACKs in the reference duration includes: determining that the number of NACKs in the reference duration exceeds a threshold, the threshold being based on a measure of channel congestion; and in response to determining that the number of NACKs in the reference duration exceeds the threshold, selecting, from among: a first contention window size and a second contention window size, greater than the first contention window size, the second contention window size as the determined contention window size.

According to an embodiment of the present disclosure, there is provided a User Equipment including: means for processing; and a memory storing instructions which, when executed by the means for processing, cause performance of: determining, by a User Equipment (UE), a measure of channel congestion, the measure of channel congestion being a channel busy ratio or a channel occupancy ratio; determining, by the UE, a determined contention window size, based on the measure of channel congestion; and waiting, during a first interval of time, without making a sidelink transmission, wherein a length of the first interval of time is based on the determined contention window size.

### BRIEF DESCRIPTION OF THE DRAWINGS

In the following section, the aspects of the subject matter disclosed herein will be described with reference to exemplary embodiments illustrated in the figures, in which:

FIG. 1 is an illustration of a channel busy ratio measurement, according to an embodiment;

FIG. 2 is a flowchart of a method for contention window size adjustment, according to an embodiment;

FIG. 3 is a flowchart of a method for contention window size adjustment, according to an embodiment;

FIG. 4 is a flowchart of a method for contention window size adjustment, according to an embodiment;

FIG. 5 is a flowchart of a method for contention window size adjustment, according to an embodiment;

FIG. 6 is an illustration of an adaptive resource selection window, according to an embodiment;

FIG. 7 is a flowchart of a method for calculating and using channel busy ratio in unlicensed spectrum, according to an embodiment;

FIG. 8 is a flowchart of a method for sidelink operation, according to an embodiment; and

FIG. 9 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Until and including in Release 17 (Rel-17) of the Fifth Generation of Mobile Telephony (5G) standard promulgated by the Third Generation Partnership Project (3GPP), the sidelink (SL) specification was focused on public safety and vehicle to vehicle (V2V) in the Intelligent Transportation Service (ITS) band. In the ITS band, while operation may be performed without network operator oversight, only one technology may be deployed on a given channel. However, for future New Radio (NR) releases, SL operation in full unlicensed systems is being considered. This makes the problem more challenging since there may be more than one technology deployed in a given unlicensed band. One of the challenges in channel access of unlicensed spectrum is how to design the contention window size (CWS) adjustment procedure for SL, in order to comply with the regulation of fairly sharing the unlicensed spectrum with other radio technologies. When a contention window is used, the User Equipment (UE) may, once it has data to transmit in a sidelink transmission, wait, during a first time interval, without making a sidelink transmission, and then make the sidelink transmission. The length of the first time interval may be based on the contention window size to be used (which may be referred to herein as the “determined contention window size”). For example, the first interval of time may be an interval that ends when a random number of channel idle time slots have passed; and the random number may be selected to be between 0 and a number that is one less than the contention window size.

Another challenge is how to enhance the existing SL congestion control algorithm based on channel busy radio (CBR) to consider the coexistence of other radio technologies. This disclosure provides solutions to solve the above two challenges for SL communication over the unlicensed spectrum below the 7 GHz band.

Rel-16 NR unlicensed channel access on contention window adjustment procedures for downlink (DL) transmissions by a network node (gNB) may be performed in accordance with 3GPP TS 37.213, as follows. If a gNB transmits transmissions including Physical Downlink Shared Channel (PDSCH) that are associated with channel access priority class p on a channel, the gNB maintains the contention window value CWₚ and adjusts CWₚ before step 1 of the procedure described in clause 4.1.1 for those transmissions using the following steps:
1) For every priority class p ∈ {1, 2, 3, 4}, set CWₚ=CW_{min,p}.
2) If hybrid automatic repeat request-acknowledgment (HARQ-ACK) feedback is available after the last update of Wₚ, go to step 3. Otherwise, if the gNB transmission after the procedure described in clause 4.1.1 does not include a retransmission or is transmitted within a duration T_{w} from the end of the reference duration corresponding to the earliest DL channel occupancy after the last update of CWₚ, go to step 5; otherwise go to step 4.
3) The HARQ-ACK feedback(s) corresponding to PDSCH(s) in the reference duration for the latest DL channel occupancy for which HARQ-ACK feedback is available is used as follows:
a. If at least one HARQ-ACK feedback is ‘ACK’ for PDSCH(s) with transport block based feedback or at least 10% of HARQ-ACK feedbacks is ‘ACK’ for PDSCH CBGs transmitted at least partially on the channel with code block group based feedback, go to step 1; otherwise go to step 4.
4) Increase CWₚ for every priority class p ∈ {1, 2, 3, 4} to the next higher allowed value.
5) For every priority class p ∈ {1, 2, 3, 4}, maintain CWₚ as it is; go to step 2.

The reference duration and duration T_{w} in the procedure above are defined as follows:
(i) The reference duration corresponding to a channel occupancy initiated by the gNB including transmission of PDSCH(s) is defined in this clause as a duration starting from the beginning of the channel occupancy until the end of the first slot where at least one unicast PDSCH is transmitted over all the resources allocated for the PDSCH, or until the end of the first transmission burst by the gNB that contains unicast PDSCH(s) transmitted over all the resources allocated for the PDSCH, whichever occurs earlier. If the channel occupancy includes a unicast PDSCH, but it does not include any unicast PDSCH transmitted over all the resources allocated for that PDSCH, then, the duration of the first transmission burst by the gNB within the channel occupancy that contains unicast PDSCH(s) is the reference duration for CWS adjustment.
(ii) T_{w}=max (T_{A}, T_{B}+1 ms) where T_{B} is the duration of the transmission burst from start of the reference duration in ms and T_{A}=5 ms if the absence of any other technology sharing the channel cannot be guaranteed on a long-term basis (e.g. by level of regulation), and T_{A}=10 ms otherwise.

If a gNB transmits transmissions using Type 1 channel access procedures associated with the channel access priority class p on a channel and the transmissions are not associated with explicit HARQ-ACK feedbacks by the corresponding User Equipments UE(s), the gNB adjusts CWₚ before step 1 in the procedures described in subclass 4.1.1, using the latest CWₚ used for any DL transmissions on the channel using Type 1 channel access procedures associated with the channel access priority class p. If the corresponding channel access priority class p has not been used for any DL transmissions on the channel, CWₚ=CW_{min,p} is used.

Certain procedures may be employed for CWS adjustments for DL transmissions. The following applies to the procedures described in clauses 4.1.4.1 and 4.1.4.2:
(i) If CWₚ=CW_{max,p}, the next higher allowed value for adjusting CWₚ is CW_{max,p}.
(ii) If the CWₚ=CW_{max,p} is consecutively used K times for generation of Nᵢₙᵢₜ, CWₚ is reset to CW_{min,p} only for that priority class p p for which CWₚ=CW_{max,p} is consecutively used K times for generation of Nᵢₙᵢₜ. K is selected by eNB/gNB from the set of values {1, 2, . . . , 8} for each priority class p ∈ {1, 2, 3, 4}.

Table 4.1.1-1 of 3GPP TS 37.213 version 16.3.0 specifies the allowed CWₚ sizes.

Sidelink congestion control in sidelink resource allocation mode 2 may be performed in accordance with 3GPP TS 38.215. The SL Channel Busy Ratio (SL CBR) measured in slot n is defined as the portion of sub-channels in the resource pool whose SL Received Signal Strength Indicator (RSSI) measured by the UE exceed a (pre-)configured threshold sensed over a CBR measurement window [n−a, n−1], wherein a is equal to 100 or 100·2^{μ} slots, according to higher layer parameter timeWindowSize-CBR. Sidelink Channel Occupancy Ratio (SL CR) evaluated at slot n is defined as the total number of sub-channels used for its transmissions in slots [n−a, n−1] and granted in slots [n, n+b] divided by the total number of configured sub-channels in the transmission pool over [n−a, n+b].

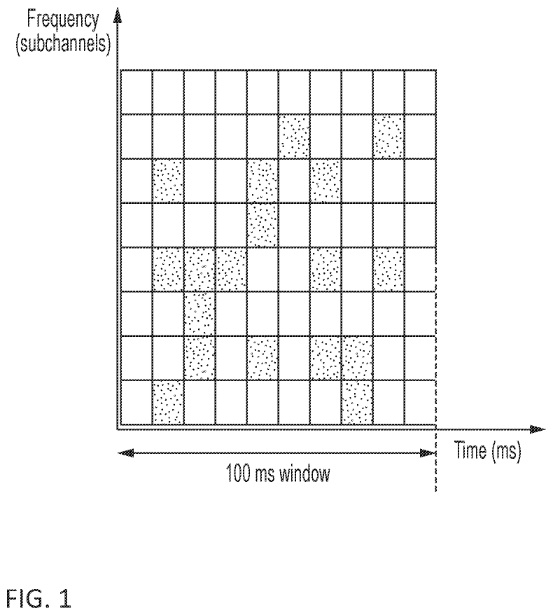

In NR sidelink, congestion control plays a key role in reducing the number of collisions between neighboring UEs. Two congestion control metrics (namely CBR and CR) jointly limit the number of transmissions a UE can do within a given duration based on its transport block (TB) priority and the channel occupancy level. In particular, a UE is expected to continuously monitor the medium and accordingly identify the number of subchannels that have an RSSI level above a given threshold with a pre-configured duration. The number of these subchannels is then divided by the total number of available subchannels within the same duration to obtain the CBR value as shown in FIG. 1.

This CBR value is then used to control the number of transmissions a UE can perform in a given duration. In NR Rel-17 the concept of CBR was relaxed for power-saving UEs to include only the slots in which they are active and they are receiving from their neighbors in order to reduce the UE's power consumption.

As specified in 3GPP TS 38.214, if a UE is configured with higher layer parameter sl-CR-Limit and transmits PSSCH in slot n, the UE shall ensure the following limits for any priority value k;

Σ_{i≥k}CR(i)≤CR_{Limit(k)}
where CR(i) is the CR evaluated in slot n-N for the PSSCH transmissions with “Priority” field in the SCI set to i, and CR_{Limit}(k) corresponds to the high layer parameter sl-CR-Limit that is associated with the priority value k and the CBR range which includes the CBR measured in slot n-N, where N is the congestion control processing time.

The congestion control processing time N is based on μ of Table 8.1.6-1 and Table 8.1.6-2 of 3GPP TS 38.214 for UE processing capability 1 and 2 respectively, where μcorresponds to the subcarrier spacing of the sidelink channel with which the PSSCH is to be transmitted. A UE shall only apply a single processing time capability in sidelink congestion control.

When NR (New Radio) sidelink (SL) is deployed on a carrier potentially occupied by other systems in the unlicensed band (SL-U), the NR SL UE needs to comply with the regulation in the unlicensed spectrum to perform channel access in the unlicensed spectrum. This may include performing listen-before-talk (LBT) protocols before accessing the system.

When performing LBT, Contention Window Size (CWS) adjustment design is an important part of the channel access. It is desirable to follow the Rel-16 New Radio Unlicensed (NRU or NR-U) CWS adjustment procedure as described above, in order to simplify the standardization effort. However, this is not straightforward: CWS adjustment for NR-U relies on the HARQ feedback, but for sidelink-unlicensed (SL-U), a NACK may be due to either interference from another system, or SL-U interference. In the extreme case where a system is heavily loaded with SL-U UEs, but where there is no other system present, the large number of NACKs may trigger large increases in CWS to protect another system that is not present. Therefore, there is a need to define a CWS adjustment process that takes into account the load on both the SL-U system and other radio access technologies (RATs) present on the carrier. This problem of interference for two systems is already present for NR-U. However, the problem may be magnified in SL-U due to the distributed nature of SL-U, as opposed to NR-U, which operates with the cellular paradigm of a central controller (the gNB) controlling multiple devices (the UEs). In addition, for SL-U, the CWS adaptation also should be enabled on SL groupcast and broadcast. Such a procedure is not supported by the NRU-16 CWS adaptation procedure since it is only applicable for unicast. This disclosure defines procedures for CWS adjustment for groupcast and broadcast transmissions, as well as for unicast transmissions.

In addition, when performing congestion control, interference can come from either other SL-U UEs, or from UEs using a different system (e.g., WiFi). If only SL is deployed, the existing mechanisms for SL congestion control based on CBR and CR work well. However, in order to coexist with other systems, new mechanisms may be defined.

In this disclosure, these two problems are addressed. In particular, the following are discussed:
(i) for the CWS adjustment procedure in SL-U channel access, how to define the triggering conditions for CWS and for unicast, groupcast 1 & 2, and broadcast, and
(ii) for SL congestion control, how to account for interference coming from the SL-U UEs and UEs from another RAT.

Two aspects of the CWS adjustment procedure design for SL-U channel access may be considered and defined: (i) how to define the “reference duration” for triggering CWS, and (ii) how to define the triggering conditions for CWS and for SL unicast, groupcast type 1 & 2, and broadcast.

As mentioned above, for enabling the contention window adjustment procedure in SL-U channel access, one issue is how to define the reference duration for collecting the measurements or the triggers to perform CWS adjustments. Generally, CWS adjustment may rely on a reference duration. For NR-U, it is defined in R1-2005809. This definition may be extended for sidelink by using PSCCH instead of the PDSCH.

However, as explained above, the negative acknowledgements (NACKs) could be either due to either the other SL-U UEs or UEs from another RAT. In some embodiments, only the UEs from the other RAT would be considered. Thus, in some embodiments, the reference duration may be a fixed pre-defined time duration during which the SL UE is constantly making LBT attempts itself, or performing CBR measurements, or receiving, from other UEs, information on LBT attempt success rates, e.g., via sidelink control information (SCI) messages or Media Access Control control elements (MAC CEs). In this case, a new metric may be defined: the “LBT attempt successful rate”, which is defined as the ratio between the number of successful LBT attempts and total number of LBT attempts within a pre-defined time duration. This duration may be communicated to other UEs via SCI or MAC CE (in a new field). Based on these receive values, and its own measured value, the UE may then adapt the reference duration.

For SL unicast, the reference duration may be defined from the slot where a given transmitting (Tx) UE obtains the channel access at a given 20 MHz resource block (RB) set to perform a first SL data transmission of a given TB, until it receives a NACK from the target receiver or no feedback is received before a pre-defined timer expires. If none of the NACKs are received before the expiration of the pre-defined timer, the reference duration is equal to the length of the pre-defined timer and Tx assumes the transmissions were successful. In another embodiment, the reference duration is a fixed pre-defined time duration during which the SL UE is constantly making LBT attempts itself, or performing CBR measurements, or receiving, from other UEs, information on LBT attempt success rates, e.g., via SCI message or MAC CE. In this case, the SCI may be enhanced to include a new codepoint “the LBT attempt success rate”, which is defined as the ratio between the number of successful LBT attempts and total number of LBT attempts within a pre-defined time duration.

For SL groupcast type 1, the reference duration may be defined from the slot where a given Tx UE obtains the channel access at a given 20 MHz RB set to perform first SL data transmission of a given TB, until it receives NACKs from the target receivers or no feedbacks are received before a pre-defined timer expires. If none of the NACKs are received before the expiration of the pre-defined timer, the reference duration is equal to the length of the pre-defined timer and Tx assumes the transmissions were successful. For groupcast type 2, the reference duration may be defined from the slot where a given Tx UE obtain the channel access at a given 20 MHz RB set to perform first SL data transmission of a given TB, until it receives ACKs/NACKs from the target receivers or no feedbacks are received before a pre-defined timer expires. If none of the NACKs are received before the expiration of the pre-defined timer, the reference duration is equal to the length of the pre-defined timer and Tx assumes the transmissions were failed. In another embodiment, the reference duration may be a fixed pre-defined time duration where the SL UE is constantly making LBT attempts itself, or performing CBR measurements, or receiving, from other UEs, information on LBT attempt success rates, e.g., via SCI message or MAC CE. In this case, the SCI may be enhanced to include a new codepoint “the LBT attempt successful rate”, which is defined as the ratio between the number of successful LBT attempts and total number of LBT attempts within a pre-defined time duration.

For SL broadcast, the reference duration may be a fixed pre-defined time duration where the SL UE is constantly making LBT attempts itself, or performing CBR measurements, or receiving, from other UEs, information on LBT attempt success rates, e.g., via SCI message or MAC CE. In this case, the SCI may be enhanced to include a new codepoint “the LBT attempt successful rate”, which is defined as the ratio between the number of successful LBT attempts and total number of LBT attempts within a pre-defined time duration.

As mentioned above, a second aspect of the CWS adjustment procedure design for SL-U channel access is how to define the triggering conditions for CWS and for SL unicast, groupcast type 1 & 2, and broadcast. At a high level, for a SL unicast transmission, the CWS may be triggered by receiving a HARQ ACK/NACK from the receiver, i.e., the CWS is doubled when receiving a NACK and re-set to the initial CW size when receiving an ACK. Alternatively, it may be based on UE CBR measurements within the defined reference duration. For example, if the CBR within the defined reference duration is larger than a first threshold (threshold1), the CW is doubled; if the CBR within the defined reference duration is smaller than a second threshold (threshold2), the CW is re-set to the initial CW size. In addition, the thresholds threshold1 and threshold2 may be a function of the priority of the TB to be transmitted at the Tx UE. For example, a high priority TB may have a larger threshold1 value such that it may be transmitted sooner than low priority TB. At the same time, a high priority TB may have smaller threshold2 value such that it may be transmitted sooner than a low priority TB.

As used herein “threshold1” means a first threshold, and “threshold2” means a second threshold. In general, when “threshold1” is mentioned in a first place in the present disclosure and “threshold1” is mentioned in a second place in the present disclosure, the “threshold1” mentioned in the second place may be the same threshold as, or a different threshold from, the “threshold1” mentioned in the first place. In general, when “threshold2” is mentioned in a first place in the present disclosure and “threshold2” is mentioned in a second place in the present disclosure, the “threshold2” mentioned in the second place may be the same threshold as, or a different threshold from, the “threshold2” mentioned in the first place.

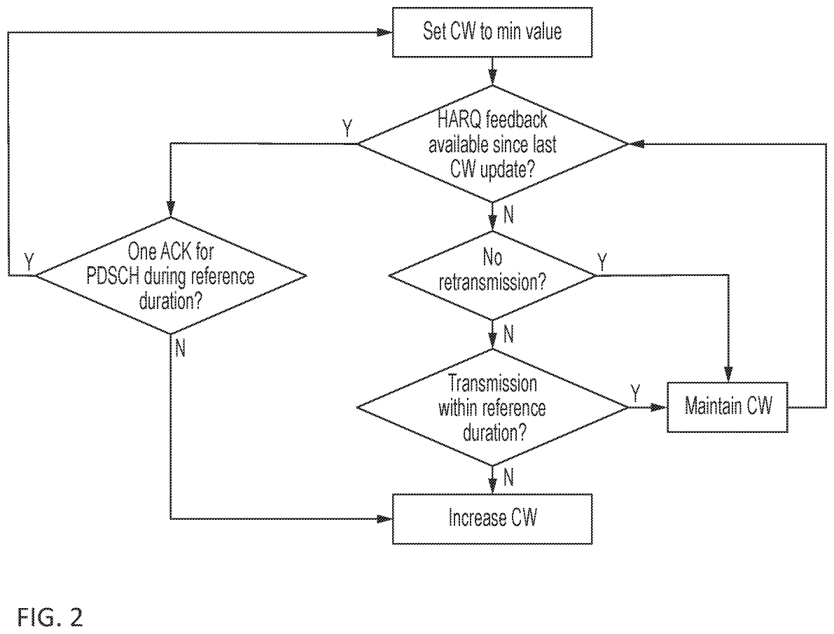

In particular, for Rel-16 NRU unicast communication, the existing procedure is shown in FIG. 2. The decision to increase or decrease the CWS is based primarily on the received ACKs. This procedure may be inadequate for sidelink-unlicensed because there is coexistence with two types of UEs: (i) UEs that communicate using NR sidelink unlicensed (type-1 UEs), and (ii) UEs that communicate using another type of system (e.g., Wifi), referred to as type-2 UEs. The increase of the CWS may be mostly to deal with type-2 UEs. For type-1 UEs, there are already existing procedures that exist to ensure fair access between UEs. Consequently, there is a need for a CWS procedure that takes into account type-2 UEs and generally ignores type-1 UEs. One way to do the differentiation is to use the CBR metrics as defined above. In particular, three metrics may be defined, as discussed in further detail below: (i) CBR_all: a metric that includes all UEs (type-1 and type-2), (ii) CBR_NR: a metric that includes only type-1 UEs, and (iii) CBR_other: a metric that includes type-2 UEs. Only two of these three metrics are needed since CBR_all=CBR_NR+CBR_other.

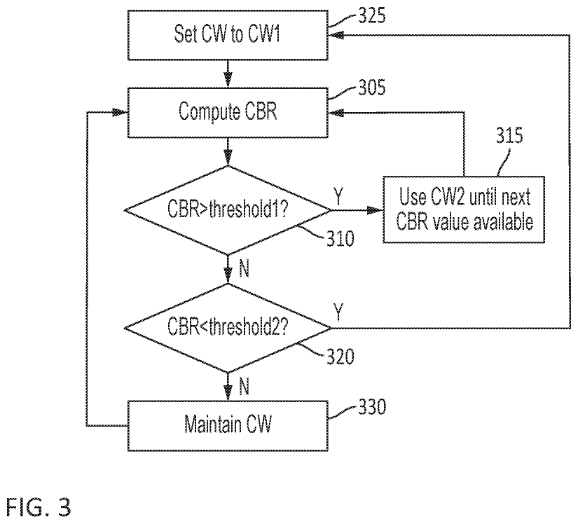

Without loss of generality, it may be assumed that two CW sizes are possible (CW1 and CW2). The system is (pre-)configured with four parameters: (i) a duration to compute the CBR (ii) which CBR to use (CBR_all, CBR_other) (iii) threshold1, and (iv) threshold2. This (pre-)configuration may be per resource pool, or per pair of UEs. In a first embodiment, the CW size is based only on CBR computations. The procedure is as shown in FIG. 3.

As shown in FIG. 3, the SL UE is initially configured with a CWS value of CW1. Then, the SL UE continuously measures, at 305, a measure of channel congestion (e.g., the CBR) of the unlicensed spectrum. If the measured CBR is larger than threshold1, the SL UE will use CW2 until the next measured CBR value is available. For example, the UE may determine, at 310, that the measure of channel congestion is greater than the first threshold (threshold1) and greater than the second threshold (threshold2); and in response to determining that the measure of channel congestion is greater than the first threshold and greater than the second threshold, the UE may select, at 315, (from among: the first contention window size (CW1) and the second contention window size (CW2), greater than the first contention window size), the second contention window size as the determined contention window size. For example, CW2 may be twice CW1. If the measured CBR is less than threshold) and also less than threshold2 (with threshold1 being greater than threshold2), the SL UE will reset the CWS to CWS1 as in the initial configuration. For example, the UE may determine, at 310 and at 320, that the measure of channel congestion is less than the first threshold and less than the second threshold; and in response to determining that the measure of channel congestion is less than the first threshold and less than the second threshold, the UE may select, at 325, from among: the first contention window size (CW1) and the second contention window size (CW2), greater than the first contention window size, the second contention window size as the determined contention window size. If the measured CBR is less than threshold1 but larger than threshold2 (with threshold1 being greater than threshold2), the SL UE maintains the current CW size, either CW2 or CW1. For example, the UE may determine, at 310 and at 320, that the measure of channel congestion is between the first threshold and the second threshold; and in response to determining that the measure of channel congestion is between the first threshold and the second threshold, leave unchanged, at 330, the determined contention window size.

In this algorithm, the CWS is only based on the CBR measurements. It is possible to have a procedure that depends on both the CBR measurements and the received NACKs. In essence, this may be done by adapting the threshold for ACK/NACKs based on the CBR. One possibility is to use an algorithm similar to the LTE algorithm for adapting the CWS.

In some examples disclosed herein, various decisions are made (e.g., the CWS is adjusted) based on the CBR. In some embodiments, such decisions may be made instead based on the CR. Both of these characteristics may be considered to be measures of channel congestion, and, as used herein, a measure of channel congestion means either the CBR or the CR.

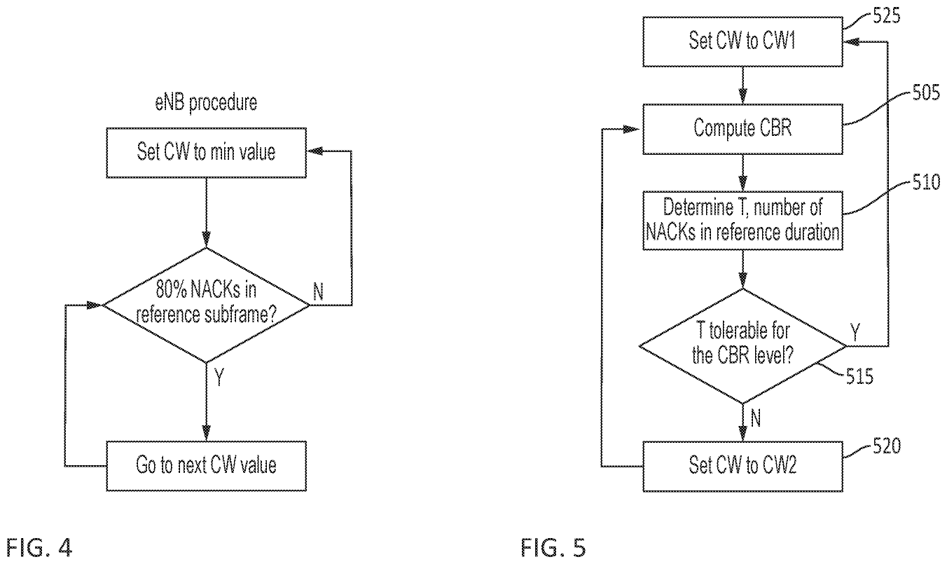

The LTE algorithm to adapt the CWS (which may be referred to as the “eNB procedure”) is shown in FIG. 4. The procedure may be modified to include the CBR; for example, a function giving the percentage of tolerable NACKs as a function of the CBR may be used, as illustrated in FIG. 5. Under some circumstances, the effect of the method of FIG. 5 may be similar to the effect of the method of FIG. 4; for instance, the 10% of NACKs for a code block group (CBG) may be adopted based on the CBR. However, given that SL-U operates mostly with slot granularity, the procedure of FIG. 5 may be more suitable and simple. Here, the UE computes the percentage of NACKs T. The procedure to compute T may be similar to that used for LTE, documented in TS37.913, Section 4.1.4.1 (for determining Z). The tolerable target for NACKs may be 80% or another (pre-) configured value, e.g., per resource pool. The reference duration may be determined as explained above. In the method of FIG. 5, the UE may, at 505, compute a channel busy ratio (or other measure of channel congestion), determine, at 510, a number of negative acknowledgements (NACKs) in a reference duration; and determine the determined contention window size based on the number of NACKs in the reference duration. The determining of the determined contention window size based on the number of NACKs in the reference duration may include: determining a threshold (T); determining, at 515, that the number of NACKs in the reference duration exceeds the threshold (T), the threshold being based on a measure of channel congestion; and in response to determining that the number of NACKs in the reference duration exceeds the threshold, selecting, at 520, from among: a first contention window size and a second contention window size, greater than the first contention window size, the second contention window size as the determined contention window size. In other circumstances, the determining of the determined contention window size based on the number of NACKs in the reference duration may include determining, at 515, that the number of NACKs in the reference duration is less than the threshold (T); and in response to determining that the number of NACKs in the reference duration is less than the threshold, selecting, at 525, from among: a first contention window size and a second contention window size, greater than the first contention window size, the first contention window size as the determined contention window size.

The thresholds threshold) and threshold2 may each be a function of the priority of the TB to be transmitted at the Tx UE. For example, a high priority TB may have a larger threshold1 value, such that it may be transmitted sooner than a low priority TB. At the same time, a high priority TB may have a smaller threshold2 value such that it may be transmitted sooner than a low priority TB. This TB priority is different than the channel access priority class (CAPC). For instance, while there are only 4 CAPC classes, there are 16 overall priority levels from SL-U. Thus, even within a given CAPC, there may be different values for the thresholds based on the priority values. Additionally, there may be a pre-defined mapping from the 16 SL priority classes to the 4 CAPC classes. For example, a mapping between PQI or PPPP values and CAPC classes may be introduced to enable in SL-U. Sidelink (PC5) quality of service (QoS) Identifier (PQI) or Prose Per Packet Priority (PPPP) values with higher QoS requirements (e.g., short latency, higher reliability) may be mapped to CAPC classes with high priority, e.g., CAPC 1 as defined above, whereas PQI or PPPP values with low QoS requirements may be mapped to CAPC classes with low priority class, e.g., CAPC 4 as defined above.

For groupcast communication option 1, only UEs within a certain range send HARQ feedback, and only NACKs are sent. Essentially, the UE performs energy/sequence detection on one Physical Sidelink Feedback Channel (PSFCH) resource to determine if at least one NACK was received. It is not possible for the UE to determine how many UEs have correctly received the transmission. The HARQ metrics could be, for example, the number of PSFCH resources where a NACK was received over the number of occupied PSFCH resources. Alternatively, if at least one NACK is received, the UE may adjust the CWS. The CWS may be triggered by the HARQ feedbacks of NACK only from the receivers, e.g., the CWS may be doubled when (i) receiving at least one NACK or when (ii) the number of PSFCH resources in which a NACK was received over the total number of occupied PSFCH resources from all receivers exceeds a threshold, e.g., X %. The CWS may be reset to the initial CW size when not receiving any NACKs or at most X % NACKs from the receivers.

Alternatively, the CWS adjustment may be based on UE CBR measurements within the defined reference duration. For example, if the CBR within the defined reference duration is larger than threshold1, the CW is increased; if the CBR within the defined reference duration is smaller than a threshold2, the CW is re-set to the initial CW size. In addition, threshold1 and threshold2 may each be a function of the priority of the TB to be transmitted at the Tx UE. For example, a high priority TB may have larger threshold1 value such that it may be transmitted sooner than a low priority TB. At the same time, a high priority TB may have smaller threshold2 value such that it may be transmitted sooner than a low priority TB.

For groupcast communication type2, individual ACKs/NACKs are received from all receivers involved in the communication link. Thus, the same metrics and principles as for unicast may be used. For example, the CWS may be triggered by the HARQ feedbacks of NACK only from the receivers, e.g., based on the ratio of NACKs to ACKs. In particular, CWS may be increased when (i) receiving at least one NACK or when (ii) the number of PSFCH resources in which a NACK was received over the total number of occupied PSFCH resources from all receivers exceeds a threshold, e.g., X %. The CWS is reset to the initial CW size when not receiving any NACKs or at most X % NACKs from the receivers. Alternatively, the CWS may also be based on UE CBR measurements within the defined reference duration (as defined earlier, or as defined differently, e.g., with a longer time span). For example, if the CBR within the defined reference duration is larger than threshold), the CWS is increased. If the CBR within the defined reference duration is smaller than threshold2, the CWS is re-set to the initial CW size. In addition, each of threshold1 and threshold2 may be a function of the priority of the TB to be transmitted at the Tx UE. For example, a high priority TB may have a larger threshold 1 value such that it may be transmitted sooner than a low priority TB. At the same time, a high priority TB may have a smaller threshold2 value such that it may be transmitted sooner than a low priority TB.

For an SL broadcast transmission, the CWS may be based on UE CBR measurements within the defined reference duration. For example, if the CBR within the defined reference duration is larger than threshold1, the CWS is increased. If the CBR within the defined reference duration is smaller than threshold2, the CWS is reset to the initial CW size. In addition, each of threshold1 and threshold2 may be a function of the priority of the TB to be transmitted at the Tx UE. For example, a high priority TB may have a larger threshold1 value such that it may be transmitted sooner than a low priority TB. At the same time, a high priority TB may have a smaller threshold2 value such that it may be transmitted sooner than a low priority TB.

Some embodiments may enhance the congestion control in SL-U by considering the shared spectrum access. On an unlicensed carrier, there is no guarantee that only SL-U UEs will be present. Thus, CBR and CR based congestion control in a sidelink scheme may not work properly if another RAT shares the same carrier, as explained above. As such, congestion control may be based on both the SL-U traffic load, as well as the channel occupancy by other system(s). In some embodiments, the congestion Control for SL-U is fully or partially based on the channel access statistics in the past. For that purpose, the congestion control metrics may be based at least partially on the number of failures or successful LBT attempts within a pre-defined period of time. These LBT metrics may be used standalone for congestion control purposes, but may also optionally be combined with the legacy CBR measurements or new system-specific CBR measurements.

In one embodiment, if the number of LBT failures or the ratio of LBT failures to LBT attempts within a given time is larger than a threshold, the SL Tx adapts its Tx behaviors to avoid the congestion in the shared spectrum with other RATs. One way of doing this is to use an adaptive resource selection window in the mode 2 resource selection procedure. For the SL-U network, the congestion control method may be based on both the CBR and the number of LBT failures or the ratio of LBT failures to LBT attempts within a given time.

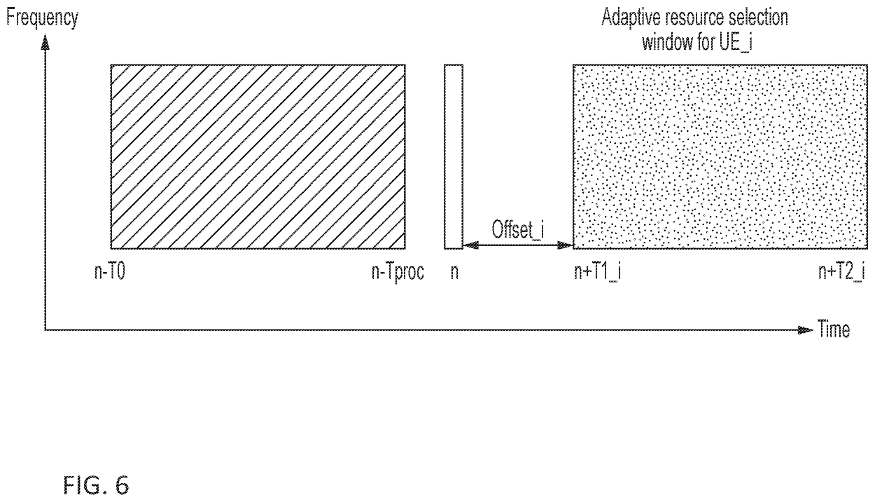

For instance, if the LBT failure ratio is higher than threshold) and the CBR measurement is lower than threshold2, the congestion is mainly from external RATs sharing the same spectrum. The UE may employ an adaptive resource selection window with a time offset and length value of the window to spread the congestion in time. Essentially, this is a way to automatically reduce the CR. One example of the adaptive resource selection window may be as illustrated in FIG. 6, where there is a UE specific mode 2 resource selection window for UE_i, with UE specific time offset and length of the window size. The time offset value and length of the window size may be adjusted based on a UE-detected congestion level in the shared spectrum. For instance, if UE_i measures that the LBT failure ratio is higher than threshold1, the time offset value and/or the resource selection window size of UE_i may be linearly increased by X slots. Alternatively, the time offset value and/or the_resource selection window size of UE_i may be exponentially multiplied by a factor of Y.

In addition to the resource selection window configuration, the following transmission parameters may also be adjusted to alleviate the congestion in the shared spectrum access:
1. The modulation and coding scheme (MCS): the Tx UE may reduce the congestion by using a higher order MCS that reduces the number of sub-channels necessary to transmit a TB.
2. The number of sub-channels: the UE may reduce the number of sub-channels it may utilize by a higher order MCS.
3. The number of (re-)transmissions: the UE may reduce the number of (re-) transmissions.
4. The transmission power: the UE may decrease the congestion by reducing its transmission power.

Adapting these parameters would require standards changes as follows: for instance, the number of allowable retransmissions would depend on the CBR level, which would require a new UE behavior not currently defined in the standards. In addition, the parameters to indicate the number of retransmissions allowed per range of CBR per priority level would have to be (pre-)configured, e.g., on a per-resource-pool basis. Another solution to reduce the congestion when the congestion comes from another system may be to reduce the probability of transmission. Before each transmission of a packet, the UE draws a random variable to determine whether to transmit the packet. The probability of transmission is associated with the packet priority, and possibly other parameters (latency, etc.).

If the LBT failure ratio is lower than threshold) and CBR measurement is higher than threshold2, then in this case the congestion is mainly from the SL-U UEs within a single network, instead of external RATs sharing the same spectrum. Thus, the legacy CBR or CR based congestion control may be used. In particular, a Tx UE may use the measured SL CBR and SL CR to identify whether it has to modify its transmission parameters to reduce the channel congestion. This may be done using a (pre-)configured lookup table that includes up to 16 CBR ranges. Each range is linked with a maximum SL CR (which may be referred to as CRlimit) that the Tx UE may not surpass. CRlimit may increase as the CBR range decreases. The value of the CRlimit for each CBR range may be a function of the priority of the TB and the absolute speed of the Tx UE. The Tx UE evaluates whether it is exceeding the CRlimit and has to modify its transmission parameters at each (re-)transmission. To this aim, the Tx UE computes the SL CR and SL CBR at slot n-Nproc for a scheduled (re-)transmission at slot n.

The following parameters may be adjusted:
1. The modulation and coding scheme (MCS): the Tx UE may reduce the congestion by using a higher order MCS that reduces the number of sub-channels necessary to transmit a TB.
2. The number of sub-channels: the UE may reduce the number of sub-channels it may utilize by a higher order MCS.
3. The number of (re-)transmissions: the UE may reduce the number of (re-) transmissions.
4. The transmission power: the UE may decrease the congestion by reducing its transmission power.

In another embodiment, the definition of LBT failure described above may be generalized into a set of sub-cases:
(i) SL-U UE LBT senses channel busy and is not be able to obtain the channel within an interval having a duration of a pre-defined number of slots
(ii) SL-U UE LBT senses and obtains the channel, but after the PSSCH transmissions receives a HARQ/NACK from the receiver or does not receive a HARQ feedback from receiver.

In another embodiment, threshold1 of LBT failure ratio may be a function of the priority of the TB and the absolute speed of the Tx UE, similar to CBR. For example, threshold) may have a higher value for higher priority TB and a lower value for lower priority TB.

The LBT successful ratio threshold may be a range of values, similar to CBR ranges, where each LBT successful ratio threshold corresponds to one CR limit or one of the resource selection window configurations. In this sense, to alleviate the congestion, the Tx UE will limit its transmission parameters based on the CR limit or one of the resource selection window configurations.

Another possibility is to separate the CBR into two separate metrics that are calculated separately. In particular, the following may be considered when calculating the CBR:
(i) CBR for resources occupied by NR UEs (CBR_NR): When calculating this CBR, a UE considers only the subchannels occupied by NR UEs. In particular, after establishing the duration over which the CBR will be measured, it identifies the subchannels that were either occupied by neighboring NR UEs or were intended to be occupied based on the received SCIs from its neighbors. Subsequently, it measures the RSSI level over these subchannels and divides them by the total number of available subchannels within the same duration. The inclusion of resources reserved by SCI in which no actual SCI was received may be either included or excluded based on resource pool configuration. This is because an NR UE might have performed a future reservation of a sidelink transmission but was not able to acquire the channel due to an LBT failure and thus these slot might not have been occupied by NR UEs. Finally, a UE may also consider a slot-based approach based on resource pool configuration, wherein if a subchannel within a slot is occupied or reserved by an NR UE then all the subchannels within the slot are considered in the CBR calculation.
(ii) CBR for resources occupied by other systems (CBR_other): When calculating this CBR, a UE considers all subchannels within slots that were neither occupied nor reserved by an NR UE within a given duration. Subsequently, the UE then measures the RSSI over these resources to identify the number of subchannels with an RSSI value above a threshold. Subsequently, the number of subchannels with RSSI above a threshold are then divided by the total number of subchannels within the same duration.

Finally, after performing these measurements, a UE will acquire two CBRs. The first CBR represents the congestion level due to the presence of NR UEs whereas the second represents the congestion level due to other systems within the unlicensed spectrum. Subsequently, to avoid being at a disadvantageous position when attempting to access the unlicensed spectrum, it may rely on the first CBR only when calculating the CR limit and its ability to reserve and use future resources. In addition, it may also use the other CBR metric to adjust its LBT parameters (e.g., change its contention window) to avoid congesting the channel and blocking other systems. The usage of the legacy CBR value or the modified two CBR metrics mentioned above in case of unlicensed spectrum may be pre-configured per resource pool.

The NR CBR metric might not reflect the actual channel occupancy in unlicensed spectrum due to the presence of other systems. An NR UE may rely on two CBR metrics to evaluate the congestion level in an unlicensed spectrum based on resource pool configuration. The first CBR metric relies on counting the number of subchannels with RSSI above a threshold that were either used or reserved by NR UEs based on the received SCI. This metric reflects the resources that were actually used or intended to be used by NR UEs. The second CBR metric relies on counting the remaining number of subchannels with RSSI above a threshold that were neither used nor reserved by NR UEs based on the received SCI from neighboring UEs.

TABLE 1

| NR Rel-16 sidelink CBR [4] | Proposed Rel-18 sidelink CBR |
|---|---|
| CBR_Legacy: SL Channel Busy Ratio | CBR_SL: This CBR measured in slot n is defined |
| (SL CBR) measured in slot n is defined | as the number of sub-channels in the set N with |
| as the portion of sub-channels in the | RSSI measured by the UE exceeding a |
| resource pool whose SL RSSI measured | (pre-)configured threshold where N is the set of |
| by the UE exceed a (pre-)configured | all subchannels within the resource pool that |
| threshold sensed over a CBR | satisfy the following |
| measurement window [n − a, n − 1], | fall within slots that contain an NR UE |
| wherein a is equal to 100 or 100 · 2^{μ} | reservation or an NR UE transmission SL RSSI |
| slots, according to higher layer parameter | measured by the UE exceed a (pre-)configured |
| sl-TimeWindowSizeCBR. | threshold. |
| | fall within a CBR measurement window [n − a, |
| | n − 1], wherein a is equal to 100 or 100 · 2^{μ}, |
| | according to higher layer parameter |
| | sl-TimeWindowSizeCBR. |
| | CBR_Unlicensed: This CBR measured in slot n |
| | is defined as the portion of sub-channels in the set |
| | N with RSSI measured by the UE exceeding a |
| | (pre-)configured threshold where N is the set of |
| | all subchannels within the resource pool that |
| | satisfy the following: |
| | fall within slots that does not contain an NR UE |
| | reservation nor an NR UE transmission |
| | fall within a CBR measurement window [n − a, |
| | n − 1], wherein a is equal to 100 or 100 · 2^{μ}, |
| | according to higher layer parameter |
| | sl-TimeWindowSizeCBR. |

Note:
CBR_Legacy = A * SL_CBR + (1 − A)*CBR_Unlicensed, where A is the portion of slots within the CBR measurement window that either contains an NR transmission or an NR reservation.

The difference between the CBR metric of some embodiments and the Rel-16 CBR metric is captured in Table 1 when sidelink reservations are also considered in the CBR measurements by resource pool configuration.

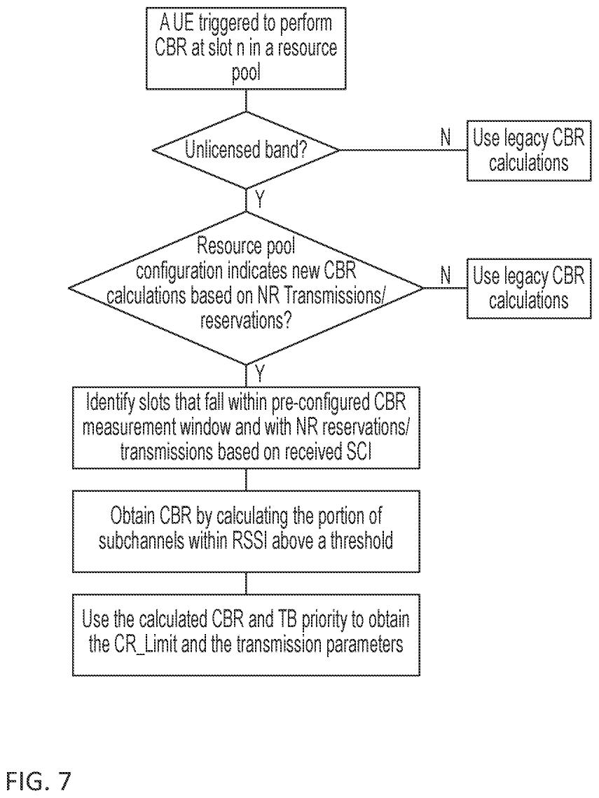

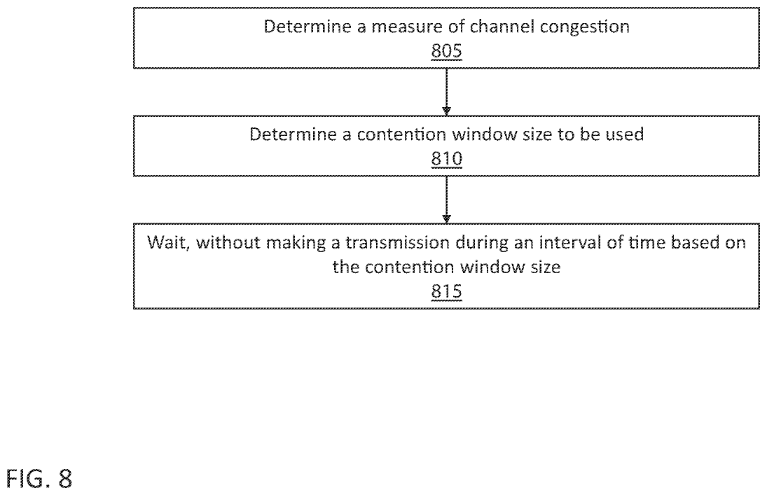

FIG. 7 illustrates the procedure for using such a CBR when operating in an unlicensed band. When calculating legacy CBR in a licensed spectrum, the UE calculates the number of subchannels with measured RSSI above a (pre)-configured threshold. When operating in unlicensed spectrum, a channel might be occupied by another system (e.g., Wifi). This may put the SL system at a disadvantage and completely block low priority SL transmissions in unlicensed spectrum when there are high Wifi activity in the channel. As such, in some embodiments, two CBR metrics may be defined (CBR SL, CBR Unlicensed), and different thresholds may be (pre)-configured for the two metrics per resource pool.

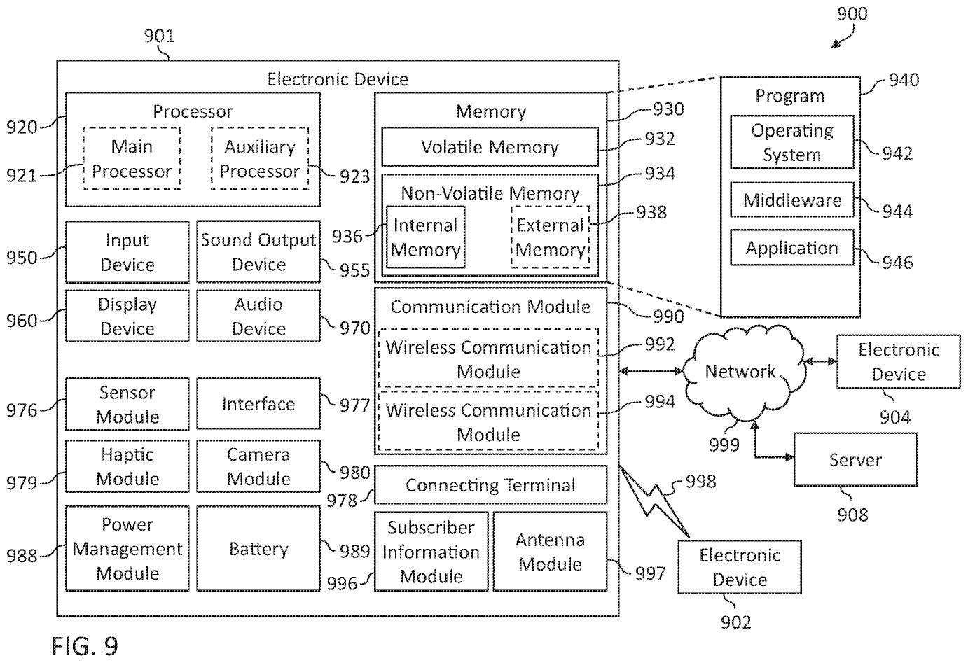

FIG. 9 is a block diagram of an electronic device in a network environment 900, according to an embodiment. The electronic device may be, or be part of, or include, a UE according to embodiments disclosed herein.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 940, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 994. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 946 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
determining, by a User Equipment (UE), a measure of channel congestion, the measure of channel congestion being a channel busy ratio or a channel occupancy ratio;
determining, by the UE, a determined contention window size, based on the measure of channel congestion; and
waiting, during a first interval of time, without making a sidelink transmission,
wherein a length of the first interval of time is based on the determined contention window size.

2. The method of claim 1, wherein:
the first interval of time is an interval that ends when a random number of channel idle time slots have passed; and
the random number is selected to be between 0 and a number that is one less than the contention window size.

3. The method of claim 1, wherein the determining of the determined contention window size comprises:
determining that the measure of channel congestion is less than a first threshold and less than a second threshold; and
in response to determining that the measure of channel congestion is less than the first threshold and less than the second threshold, selecting, from among:
a first contention window size and
a second contention window size, greater than the first contention window size,
the first contention window size as the determined contention window size.

4. The method of claim 3, wherein the determining of the contention window size further comprises:
determining that the measure of channel congestion is greater than a first threshold and greater than a second threshold; and
in response to determining that the measure of channel congestion is greater than the first threshold and greater than the second threshold, selecting, from among:
a first contention window size and
a second contention window size, greater than the first contention window size,
the second contention window size as the determined contention window size.

5. The method of claim 1, wherein the determining of the contention window size further comprises:
determining that the measure of channel congestion is between a first threshold and a second threshold; and
in response to determining that the measure of channel congestion is between the first threshold and the second threshold, leaving unchanged the determined contention window size.

6. The method of claim 1, wherein the determining of the determined contention window size comprises:
determining a number of negative acknowledgements (NACKs) in a reference duration; and
determining the determined contention window size based on the number of NACKs in the reference duration.

7. The method of claim 6, wherein the determining of the determined contention window size based on the number of NACKs in the reference duration comprises:
determining that the number of NACKs in the reference duration exceeds a threshold, the threshold being based on a measure of channel congestion; and
in response to determining that the number of NACKs in the reference duration exceeds the threshold, selecting, from among:
a first contention window size and
a second contention window size, greater than the first contention window size,
the second contention window size as the determined contention window size.

8. The method of claim 6, wherein the determining of the determined contention window size based on the number of NACKs in the reference duration comprises
determining that the number of NACKs in the reference duration is less than a threshold, the threshold being based on a measure of channel congestion; and
in response to determining that the number of NACKs in the reference duration is less than the threshold, selecting, from among:
a first contention window size and
a second contention window size, greater than the first contention window size,
the first contention window size as the determined contention window size.

9. The method of claim 6, wherein the determining of the determined contention window size comprises determining of the determined contention window size based on the ratio of:
the number of NACKs in the reference duration, to
the number of acknowledgments (ACKs) and NACKs in the reference duration.

10. The method of claim 6, wherein the reference duration is defined:
to begin in a slot in which the UE obtains channel access to perform a first transmission of a transport block; and
to end at the earlier of:
when the UE receives a NACK, or
when a set time expires.

11. The method of claim 6, wherein the reference duration is defined:
to begin in a slot in which the UE obtains channel access to perform a first transmission of a transport block; and
to end at the earlier of:
when the UE receives an acknowledgment (ACK) or a NACK, or
when a set time expires.

12. The method of claim 6, wherein the reference duration is defined to be a set duration.

13. A system, comprising:
a User Equipment (UE) comprising:
one or more processors; and
a memory storing instructions which, when executed by the one or more processors, cause performance of:
determining, by a User Equipment (UE), a measure of channel congestion, the measure of channel congestion being a channel busy ratio or a channel occupancy ratio;
determining, by the UE, a determined contention window size, based on the measure of channel congestion; and
waiting, during a first interval of time, without making a sidelink transmission,
wherein a length of the first interval of time is based on the determined contention window size.

14. The system of claim 13, wherein:
the first interval of time is an interval that ends when a random number of channel idle time slots have passed; and
the random number selected to be between 0 and a number that is one less than the contention window size.

15. The system of claim 13, wherein the determining of the determined contention window size comprises:
determining that the measure of channel congestion is less than a first threshold and less than a second threshold; and
in response to determining that the measure of channel congestion is less than the first threshold and less than the second threshold, selecting, from among:
a first contention window size and
a second contention window size, greater than the first contention window size,
the first contention window size as the determined contention window size.

16. The system of claim 15, wherein the determining of the contention window size further comprises:
determining that the measure of channel congestion is greater than a first threshold and greater than a second threshold; and
in response to determining that the measure of channel congestion is greater than the first threshold and greater than the second threshold, selecting, from among:
a first contention window size and
a second contention window size, greater than the first contention window size,
the second contention window size as the determined contention window size.

17. The system of claim 13, wherein the determining of the contention window size further comprises:
determining that the measure of channel congestion is between a first threshold and a second threshold; and
in response to determining that the measure of channel congestion is between the first threshold and the second threshold, leaving unchanged the determined contention window size.

18. The system of claim 13, wherein the determining of the determined contention window size comprises:
determining a number of negative acknowledgements (NACKs) in a reference duration; and
determining the determined contention window size based on the number of NACKs in the reference duration.

19. The system of claim 18, wherein the determining of the determined contention window size based on the number of NACKs in the reference duration comprises:
determining that the number of NACKs in the reference duration exceeds a threshold, the threshold being based on a measure of channel congestion; and
in response to determining that the number of NACKs in the reference duration exceeds the threshold, selecting, from among:
a first contention window size and
a second contention window size, greater than the first contention window size,
the second contention window size as the determined contention window size.

20. A User Equipment comprising:
means for processing; and
a memory storing instructions which, when executed by the means for processing, cause performance of:
determining, by a User Equipment (UE), a measure of channel congestion, the measure of channel congestion being a channel busy ratio or a channel occupancy ratio;
determining, by the UE, a determined contention window size, based on the measure of channel congestion; and
waiting, during a first interval of time, without making a sidelink transmission,
wherein a length of the first interval of time is based on the determined contention window size.
